(19) United States
(12) Patent Application Publication
(10) Pub. No.: US 2024/0342798 A1
(43) Pub. Date: Oct. 17, 2024

(54) MULTILAYER STRUCTURE MANUFACTURING DEVICE AND MULTILAYER STRUCTURE MANUFACTURING METHOD

(71) Applicant: TAIYO NIPPON SANSO CORPORATION, Tokyo (JP)

(72) Inventors: Hiroki AMANO, Tokyo (JP); Tomohiro OYAMA, Tokyo (JP); Tomoaki SASAKI, Tokyo (JP)

(21) Appl. No.: 18/579,667

(22) PCT Filed: Jul. 14, 2022
(86) PCT No.: PCT/JP2022/027747

§ 371 Date: Jan. 16, 2024

(30) Foreign Application Priority Data
Jul. 26, 2021 (JP) 2021-121440

(51) Int. Cl. B22F 10/28; B22F 10/64; B22F 12/00; B22F 12/30; B22F 12/70; B22F 12/90

(52) U.S. Cl. CPC B22F 10/28; B22F 10/64; B22F 12/30; B22F 12/38; B22F 12/70; B22F 12/90; B22F 2203/11

(57) ABSTRACT

One object of the present invention is to provide a multilayer structure manufacturing device and a multilayer structure manufacturing method, which enable control to accelerate the cooling rate in any layer region and facilitates the development of a desired metal structure by controlling the cooling rate. The present invention provides a multilayer structure manufacturing device (1A) including a laser oscillator (14), a chamber (3), a build stage (4) including a powder bed (8) of metal powder M that is movable in the vertical direction in the chamber (3), a plurality of temperature measurement probes (5A, 5B) that measure the temperature of the metal layer or the multilayer structure (20) in the process of being manufactured, and a plurality of temperature adjustment probes (6A, 6B) that adjust the temperature of the metal layer or the multilayer structure (20) in the process of being manufactured, and the temperature measurement probe (5A) and the temperature adjustment probe (5B) are embedded inside the powder bed (5) of the build stage (4).

### TECHNICAL FIELD

The present invention relates to a multilayer structure device and a multilayer structure manufacturing method.

### BACKGROUND ART

There is an additive manufacturing technology called “Additive Manufacturing”. As an example of additive manufacturing technology, a method for producing a multilayer structure is known in which a three-dimensional structure is manufactured by forming layers of resin, metal, and the like, and layering the formed layers. For example, a multilayer structure of an arbitrary shape can be manufactured as a three-dimensional structure by sequentially layering metal layers obtained by irradiating energy rays based on arbitrary CAD (Computer Aided Design) data. Additive manufacturing technology is applied to the fields of industrial equipment including aircraft-related parts, and medical equipment, and is attracting attention as a promising technology.

In recent years, it has been proposed not only to control the arbitrary shape of a three-dimensional structure, but also to control the crystal structure of the three-dimensional structure. The crystal structure of the three-dimensional structures is important in controlling mechanical properties. A crystal structure with preferential crystal orientation can impart anisotropy in Young's modulus, yield stress, fatigue resistance, and the like to a multilayer structure. Further, by making the crystals finer, anisotropy such as yield stress and hardness can be imparted.

As an example, it has been proposed to control the cooling rate of a multilayer structure in the process of being manufactured in order to control the crystal structure. In the field of additive manufacturing technology, the following (1) to (4) have been proposed as multilayer structure manufacturing devices that control the cooling rate.

(1) Devices that manufactures a multilayer structure having directional solidification or single-crystalline microstructures by controlling the temperature and heating rate of the multilayer structure in the process of being manufactured using induction coils as an external thermal control device (for example, Patent Document 1).

(2) Devices that controls the temperature gradient of any layer region in the multilayer structure by controlling the energy ray irradiation source for preheating before layering each layer of the multilayer structure or reheating after layering each layer (for example, Patent Document 2).

(3) Devices that controls the solidification rate of molten metal by adjusting processing parameters (power level of the energy rays, rate of depositing powder in the melt pool, processing rate of the energy rays, introduction of residence time, temperature of the substrate, and the like) based on the actual solidification rate of the melt pool formed by the energy rays (for example, Patent Document 3). The actual solidification rate of the melt pool is determined by measuring the temperature of the melt pool with a camera, quantifying the physical parameters of the transition region of the melt pool, and comparing between the physical parameters and the processing rate of the energy rays.

(4) Devices that carry out a temperature monitoring process for monitoring the temperature of the weld bead formed by the torch and a peening process in which the torch is struck with a striking tool to strike the weld bead at a first interval obtained based on the temperature of the weld bead (for example, Patent Document 4).

However, the devices (1) control the cooling rate of the entire multilayer structure. Therefore, the cooling rate cannot be adjusted at any point in the multilayer structure.

The devices (2) control the amount of heat given to each layer by controlling the energy ray irradiation source. Therefore, when the target temperature of the layer region of which the temperature gradient is to be controlled is low, the cooling capacity is insufficient. In this case, the time it takes to reach the target temperature due to cooling becomes relatively long, and it is impossible to control the process to manufacture a metal structure that will not develop unless the target temperature is reached in a shorter time.

Controlling the process parameters like the devices (3) cannot increase the cooling rate, and the cooling rate close to natural cooling is the limit. Therefore, it is impossible to control to manufacture a metal structure that only appears at a higher cooling rate.

When a powder bed fusion (PBF) method is adopted in the devices (4), the use of a striking tool interferes the metal powder layer other than the molten part due to the impact by the strike, and interferes with the formation of the powder layer before laser irradiation and the fabricating of a multilayer structure. Furthermore, when a directed energy deposition (DED) method is adopted, the impact by the strike interferes the powder supplied, and interferes with the formation of the metal layer and the fabricating of the multilayer structure.

On the other hand, in the field of metal welding, as shown in Patent Document 5, a method is known in which air is cooled by the Joule-Thomson effect and is blown onto a welded part to cool it. However, when this method is applied to a PBF-type metal 3D printer, metal powder other than the melted part is scattered by spraying the coolant, and interferes with the formation of the powder layer before laser irradiation and the fabricating of a multilayer structure. Furthermore, when this method is applied to a DED type metal 3D printer, the powder supplied is interfered by spraying the coolant, and it interferes with the formation of the metal layer and the fabricating of a multilayer structure.

As explained above, although it has been proposed to control the cooling rate of a multilayer structure in the process of being manufactured, conventional methods have the problem that the cooling rate cannot be promoted at any layer region, and as a result, it is difficult to develop a desired metal structure. Another problem is that it is difficult to apply cooling methods to achieve a sufficient cooling rate in the field of metal welding to metal 3D printers.

### PRIOR ART DOCUMENTS

### Patent Documents

Patent Document 1: Japanese Patent No. 6216881
Patent Document 2: Published Japanese Translation No. 2019-518873 of the PCT International Publication
Patent Document 3: Published Japanese Translation No. 2020-523476 of the PCT International Publication
Patent Document 4: Japanese Unexamined Patent Application, First Publication No. 2019-141854
Patent Document 5: Japanese Examined Patent Publication, Second Publication No. S61-3595

### SUMMARY OF INVENTION

### Problem to be Solved by the Invention

The present invention provides a multilayer structure manufacturing device and a multilayer structure manufacturing method, which enable control to accelerate the cooling rate in any layer region and facilitates the development of a desired metal structure by controlling the cooling rate.

### Means for Solving the Problem

[1] A multilayer structure manufacturing device that manufactures a multilayer structure by layering multiple metal layers formed by irradiating metal powder with energy rays, wherein the multilayer structure manufacturing device includes: an energy ray irradiation source; a chamber; a build stage including a powder bed of metal powder that is movable in the vertical direction in the chamber; one or more temperature measurement probes that measure the temperature of the metal layer or the multilayer structure in the process of being manufactured; and one or more temperature adjustment probes that adjust the temperature of the metal layer or the multilayer structure in the process of being manufactured; and wherein at least one of the temperature measurement probes and at least one of the temperature adjustment probes are embedded inside the powder bed of the build stage.
[2] The multilayer structure manufacturing device according to [1], wherein the build stage further includes a storage section that stores metal powder before being irradiated with the energy rays, and wherein at least one of the temperature adjustment probes is embedded inside the storage section of the build stage.
[3] The multilayer structure manufacturing device according to [1] or [2], wherein the temperature adjustment probe adjusts the temperature of the metal layer or the multilayer structure in the process of being manufactured using the Joule-Thomson effect.
[4] The multilayer structure manufacturing device according to any one of [1] to [3], wherein the temperature adjustment probe cools the metal layer or the multilayer structure in the process of being manufactured using liquefied gas.
[5] The multilayer structure manufacturing device according to [3] or [4], wherein an exhaust line through which gas exhausted from the temperature adjustment probe flows and a shield gas supply line through which a shield gas supplied into the chamber flows are connected.
[6] The multilayer structure manufacturing device according to any one of [1] to [5], wherein at least one of the temperature adjustment probes is extendably installed such that the tip thereof is disposed in the chamber.
[7] A multilayer structure manufacturing method using the multilayer structure manufacturing device according to any one of [1] to [6], wherein the method includes: a step in which the cooling rate of the metal layer or the multilayer structure in the process of being manufactured is controlled by using the temperature measurement probe and the temperature adjustment probe which are embedded inside the powder bed of the build stage.

### Effects of the Invention

According to the present invention, it is possible to control the cooling rate in any layer region, and to provide a manufacturing device and a manufacturing method of a multilayer structure that facilitates the development of a desired metal structure by controlling the cooling rate.

### BRIEF DESCRIPTION OF DRAWINGS

FIG. 1 is a schematic diagram showing an example of a multilayer structure manufacturing device.

FIG. 2 is a schematic diagram showing the operation of the multilayer structure manufacturing device shown in FIG. 1.

FIG. 3 is a schematic diagram showing an example of a temperature adjustment probe and a temperature measurement probe.

FIG. 4 is a schematic diagram showing an example of a temperature adjustment probe.

FIG. 5 is a schematic diagram showing another example of a temperature adjustment probe.

FIG. 6 is a schematic diagram showing another example of a multilayer structure manufacturing device.

FIG. 7 is a schematic diagram showing another example of a multilayer structure manufacturing device.

FIG. 8 is a schematic diagram showing a storage section of a build stage of the multilayer structure manufacturing device shown in FIG. 7.

FIG. 9 is a schematic diagram showing another example of a multilayer structure manufacturing device.

FIG. 10 is a schematic diagram showing the operation of a temperature adjustment probe and a temperature measurement probe in a DED type manufacturing device.

FIG. 11 is a schematic diagram showing the operation of a temperature adjustment probe and a temperature measurement probe in a DED type manufacturing device.

FIG. 12 is a schematic diagram showing the operation of a temperature adjustment probe and a temperature measurement probe in a WAAM type manufacturing device.

FIG. 13 is a schematic diagram showing the operation of a temperature adjustment probe and a temperature measurement probe in a WAAM type manufacturing device.

### DETAILED DESCRIPTION OF THE PREFERRED EMBODIMENTS

In the present description, “˜” indicating a numerical range means that the numerical values before and after are included as the lower limit value and the upper limit value.

Hereinafter, embodiments of the present invention will be described in detail by way of example with reference to the drawings. In the drawings used in the following explanation, characteristic parts may be shown enlarged for convenience in order to make the characteristics easier to understand, and the dimensional ratios of each component are not necessarily the same as in reality.

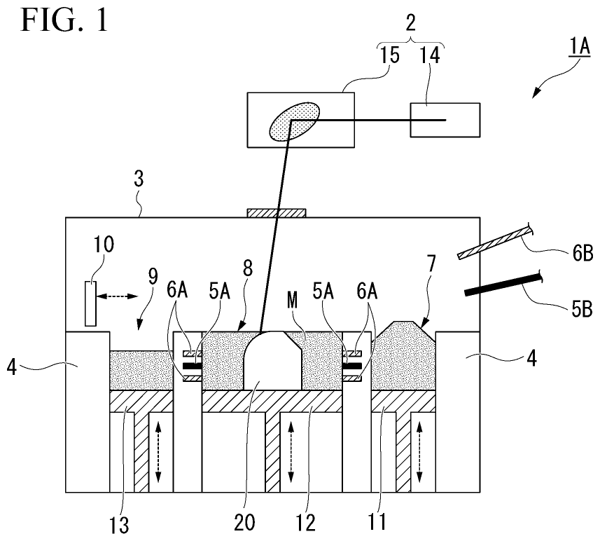

FIG. 1 is a schematic diagram showing a multilayer structure manufacturing device according to an embodiment of the present invention.

The multilayer structure manufacturing device 1A shown in FIG. 1 includes an irradiation section 2 including an energy ray irradiation source, a chamber 3, a build stage 4, a plurality of temperature measurement probes 5A and 5B, and a plurality of temperature adjustment probes 6A and 6B, and a control unit (not shown).

The irradiation unit 2 includes a laser oscillator 14 (energy ray irradiation source) and an optical system 15. The optical system 15 reflects the laser from the laser oscillator 14 and irradiates the metal powder M in the build stage 4 with the laser while scanning.

The optical system 15 is not particularly limited as long as it can control the reflection position of the laser irradiated onto the metal powder from the laser oscillator 14 according to data input in advance. The optical system 15 can be composed of, for example, one or more reflecting mirrors.

Since both the laser oscillator 14 and the optical system 15 are electrically connected to the control section (not shown), the irradiation section 2 can control the reflection direction of the laser using the optical system 15 according to instructions from a control unit (not shown). Then, the irradiation unit 2 controls the reflection direction of the laser by the optical system 15, and scans and irradiates the laser.

The metal powder is not particularly limited. Examples of the metal powder include powders of various metals such as carbon, boron, magnesium, calcium, chromium, copper, iron, manganese, molybdenum, cobalt, nickel, hafnium, niobium, titanium, aluminum, and alloys thereof.

The particle size of the metal powder is also not particularly limited. For example, the particle size can be about 10˜200 μm.

The chamber 3 is a housing in which a multilayer structure is manufactured. A shield gas supply line (not shown) is connected to the upper side surface of the chamber 3. The shield gas supply line introduces a shield gas into the chamber 3.

The shielding gas is a gas supplied around the metal powder in the chamber 3 during laser irradiation. As the shielding gas, an inert gas is preferable, and argon gas is more preferable.

The build stage 4 is a place for repeating the formation of a metal layer having an arbitrary shape and the layering of the metal layer formed. The build stage 4 is provided in the chamber 3. The build stage 4 includes a storage section 7, a powder bed 8, a collection section 9, and a blade 10. The blade 10 reciprocates along the horizontal direction in the figure.

The storage section 7 stores the metal powder M before being irradiated with energy rays (laser). The storage section 7 includes metal powder M to be supplied to the powder bed 8 and a first lifting table 11 on which the metal powder M is placed. As the first lifting table 11 rises, the metal powder M is deposited above the upper surface of the build stage 4. The deposited metal powder M is moved along the horizontal direction in the figure by the blade 10 and is supplied to the powder bed 8. The surface of the metal powder M on the powder bed 8 is made flat by the blade 10.

The powder bed 8 includes the metal powder M, a second lifting table 12 on which the metal powder M is placed, and a base plate (not shown) placed on the surface of the second lifting table 12. The base plate is a plate on which the multilayer structure is placed.

The blade 10, the first lifting table 11, and the second lifting table 12 are electrically connected to the control section (not shown). Therefore, the blade 10 and the first lifting table 11 can supply the metal powder in the storage section 7 to the powder bed 8 according to instructions from the control section.

The second lifting table 12 is movable along the vertical direction in the figure. Therefore, the powder bed 8 of metal powder is movable in the vertical direction in the chamber 3. When the second lifting table 12 descends by Δh in the vertical direction, a powder layer of the metal powder M having a thickness of Δh is formed on the powder bed 8. The vertical descending distance Δh of the second lifting table 12 corresponds to the layer thickness Δh of the powder bed for each metal layer of the multilayer structure.

The second lifting table 12 is electrically connected to the control section (not shown). Therefore, the second lifting table 12 can control the layer thickness Δh of the powder bed according to instructions from the control section.

The collection section 9 has a third lifting table 13. The third lifting table 13 is movable along the z-axis direction. In the multilayer structure manufacturing device 1A, when the powder bed 8 is formed by the blade 10, excess metal powder can be collected in the collection section 9. Furthermore, when collecting the multilayer structure after fabricating, the metal powder remaining in the build stage 4 can be moved to the collection section 9 by the blade 10 and collected.

The plurality of temperature measurement probes 5A and 5B are for measuring the temperature of the metal layer or the multilayer structure 20 in the process of being manufactured. The plurality of temperature measurement probes 5A and 5B can measure the temperature of any metal layer or any region of the multilayer structure 20 that is being manufactured by having their tips come into contact with the metal layer or the multilayer structure 20 in the process of being manufactured.

Among the plurality of temperature measurement probes 5A and 5B, some of the temperature measurement probes 5A are embedded inside the powder bed 8 of the build stage 4 and are extendably installed in the powder bed 8. Therefore, when the temperature of the metal layer or the multilayer structure 20 in the process of being manufactured is measured by the temperature measurement probe 5A, it is unlikely to interfere with the formation of the powder layer before laser irradiation, the formation of the metal layer, and the fabricating of the multilayer structure 20.

Among the plurality of temperature measurement probes 5A and 5B, the temperature measurement probe 5B is extendably installed in the chamber 3. The temperature measurement probe 5B can also measure the temperature of the atmospheric gas inside the chamber 3.

Each temperature measurement probe is not particularly limited as long as it can measure the temperature of the metal layer, the multilayer structure 20 in the process of being manufactured, or the atmospheric gas in the chamber 3.

The plurality of temperature adjustment probes 6A, 6B are for adjusting the temperature of the metal layer or the multilayer structure 20 in the process of being manufactured. The plurality of temperature adjustment probes 6A, 6B can adjust the temperature of any metal layer or any region of the multilayer structure 20 in the process of being manufactured by having their tips come into contact with the metal layer or the multilayer structure 20 in the process of being manufactured. The temperature adjustment probes 6A and 6B may be ones that adjust the temperature by heating the metal layer or the multilayer structure 20 in the process of being manufactured, or may be ones that adjust the temperature by cooling the metal layer or the multilayer structure 20 in the process of being manufactured.

Among the plurality of temperature adjustment probes 6A and 6B, some of the temperature adjustment probes 6A are embedded inside the powder bed 8 of the build stage 4 and are extendably installed in the powder bed 8. Therefore, when the temperature of the metal layer or the multilayer structure 20 in the process of being manufactured is adjusted by the temperature adjustment probe 6A, the formation of the powder layer before laser irradiation, the formation of the metal layer, and the fabricating of the multilayer structure 20 are hardly interfered.

Among the plurality of temperature adjustment probes 6A and 6B, the temperature adjustment probe 6B is extendably installed in the chamber 3. The temperature adjustment probe 6B can adjust the temperature of the atmospheric gas in the chamber 3 by heating or cooling.

Each temperature adjustment probe is not particularly limited as long as it can heat or cool the metal layer, the multilayer structure 20 in the process of being manufactured, or the atmospheric gas in the chamber 3.

The plurality of temperature measurement probes 5A, 5B and the plurality of temperature adjustment probes 6A, 6B are electrically connected to the control section (not shown). Therefore, by combining the operations of the plurality of temperature measurement probes 5A, 5B and the plurality of temperature adjustment probes 6A, 6B, the cooling rate of any metal layer or any region of the multilayer structure 20 in the process of being manufactured can be controlled. In other words, the cooling rate of the metal layer and the multilayer structure 20 in the process of being manufactured can be controlled by being made the plurality of temperature measuring probes 5A, 5B into contact with the metal layer after laser irradiation or an any area of the multilayer structure 20 in the process of being manufactured to measure the temperatures, and using the plurality of temperature adjustment probes 6A, 6B based on the measured temperatures.

The control unit (not shown) may include, for example, a central processing unit (CPU), a memory, and a hard disk drive. The hard disk drive may include CAD applications and CAM applications. In this case, three-dimensional structural data of a multilayer structure of a desired shape can be created in the control unit. CAM is an abbreviation for Computer Aided Manufacturing.

The control unit (not shown) creates processing condition data based on the three-dimensional structure data. The processing condition data can be created for each metal layer. The control unit (not shown) controls the irradiation unit 2 (laser oscillator 14 and optical system 15) based on the processing condition data, and can adjust laser output, scanning speed, scanning interval, and irradiation position.

The operation of the multilayer structure manufacturing device 1A when a multilayer structure is manufactured by layering a plurality of metal layers formed by irradiating energy rays will be described with reference to FIG. 1.

Before laser irradiation, the shielding gas is supplied into the chamber 3 from the shielding gas supply pipe (not shown). The shielding gas may also be supplied to the hollow portions below the first lifting table 11, the second lifting table 12, and the third lifting table 13. This satisfactorily fills the shielding gas in the chamber 3.

In the multilayer structure manufacturing device TA, a multilayer structure is manufactured by layering a plurality of metal layers formed by irradiating metal powder with energy rays. Based on the CAD data of the multilayer structure, the formation of the powder bed, the formation of the metal layer, and the layering of the metal layer are repeated an arbitrary number of times.

Hereinafter, as an example, a case will be described in which forming a powder bed, forming a metal layer, and layering the metal layer are repeated n times to manufacture a multilayer structure having n metal layers. Here n is a natural number.

In the multilayer structure manufacturing device 1A, the irradiation section 2 irradiates the metal powder on the powder bed 8 with a laser to sinter or melt and solidify the metal powder M at the irradiation position. Therefore, a metal layer of sintered metal powder or a metal layer of molten solidified metal powder can be formed on the powder bed 8 in any shape.

The first layer formed by the first laser irradiation, that is, the lowest metal layer, contacts a base plate (not shown) on the surface of the second lifting table 12. Next, metal layers are sequentially layered on top of the first metal layer.

In forming the k-th layer powder bed, the metal powder in the reservoir 7 is supplied to the surface of the k−1th metal layer by the blade 10, and the powder bed with a layer thickness Δh is formed on the k−1th layer. Here, k is a natural number greater than or equal to 2 and less than or equal to n.

A laser is irradiated onto this powder bed with a layer thickness of Δh to form a k-th metal layer. In forming the k-th metal layer, the powder layer is sintered or melted and solidified by laser scanning. As a result, the k-th metal layer is layered on top of the k−1-th metal layer.

By repeating the formation of the powder bed, the formation of the metal layer, and the layering the metal layer in this way, a multilayer structure in which a plurality of metal layers are layered can be manufactured. When the formation and layering of the n-th metal layer is completed, the multilayer structure having the n-th metal layer is collected from the chamber 3 while being placed on the base plate.

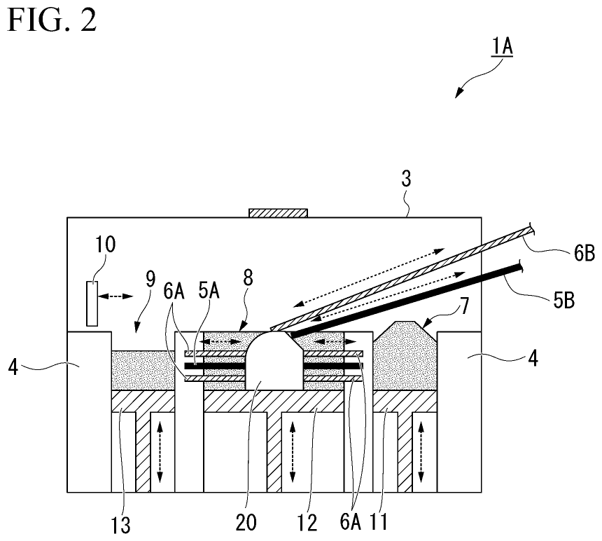

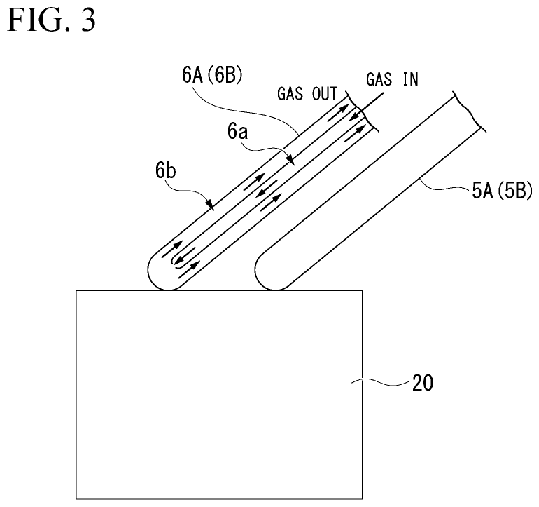

Next, the operation of the multilayer structure manufacturing device 1A when controlling the cooling rate of the multilayer structure will be explained with reference to FIGS. 2 and 3. In FIG. 2, illustration of the irradiation unit 20 is omitted for the sake of simplifying the explanation.

As shown in FIGS. 2 and 3, the plurality of temperature measurement probes 5A and 5B are extended, and the tips of each probe are in contact with the multilayer structure 20 in the process of being manufactured. Further, the plurality of temperature adjustment probes 6A and 6B are extended, and the tips of each probe are in contact with the multilayer structure 20 in the process of being manufactured.

As shown in FIG. 3, the temperature adjustment probes 6A, 6B have a double pipe structure including an inner pipe line 6a and an outer pipe line 6b. Gas is supplied into the inner pipe line 6a. The inner pipe line 6a and the outer pipe line 6b communicate with each other at the tip of the probe. The gas supplied into the inner pipe line 6a heats or cools the metal layer, and the like at the tip of the probe, flows into the outer pipe line 6b, and is exhausted outside the probe. Here, if this exhaust gas can be used as a shielding gas, the exhaust gas may be supplied into the chamber 3 via a shielding gas supply pipe (not shown).

The multilayer structure manufacturing device 1A controls the temperature adjustment probe based on the temperature measured by the temperature measurement probe according to instructions from the control unit. The temperature adjustment probe heats or cools the metal layer or the multilayer structure 20 in the process of being manufactured according to instructions from the control unit, and controls the cooling rate of any metal layer or any region of the multilayer structure 20 in the process of being manufactured.

The temperature measurement probe 5A and the temperature adjustment probe 6A are embedded inside the powder bed 8 of the build stage 4. Therefore, when the cooling rate of the metal layer or the multilayer structure 20 in the process of being manufactured is controlled by the temperature measurement probe 5A and the temperature adjustment probe 6A, the formation of the powder layer before laser irradiation, the formation of the metal layer, and the fabricating of the multilayer structure 20 may be hardly interfered.

### Effects

The multilayer structure manufacturing device 1A described above includes one or more temperature measurement probes 5A, 5B that measure the temperature of the metal layer or the multilayer structure in the process of being manufactured, and one or more temperature adjustment probes 6A and 6B that adjust the temperature of the metal layer or the multilayer structure in the process of being manufactured. Therefore, by combining the temperature measurement probes 5A, 5B and the temperature adjustment probes 6A, 6B, it becomes possible to control the cooling rate in any metal layer or any region of the multilayer structure in the process of being manufactured.

In addition, in the multilayer structure manufacturing device 1A, the temperature measurement probe 5A among the plurality of temperature measurement probes 5A and 5B is embedded inside the powder bed 8 of the build stage 4. Moreover, the temperature adjustment probe 6A among the plurality of temperature adjustment probes 6A and 6B is embedded inside the powder bed 8 of the build stage 4. Therefore, if the cooling rate is controlled by the temperature measurement probe 5A and the temperature adjustment probe 6A, the formation of the powder layer before laser irradiation, the formation of the metal layer, and the fabricating of the multilayer structure are hardly interfered.

Furthermore, according to the multilayer structure manufacturing method using the multilayer structure manufacturing device 1A, by using the temperature measurement probe 5A and the temperature adjustment probe 6A which are embedded inside the powder bed 8 of the build stage 4, it is possible to control the cooling rate at any region of the metal layer or the multilayer structure 20 in the process of being manufactured. Therefore, it is possible to control the cooling rate in any region in layers without interfering with the formation of the powder layer, the metal layers, and the fabricating of the multilayer structure, and it becomes easier to develop the desired metal structure by controlling the cooling rate.

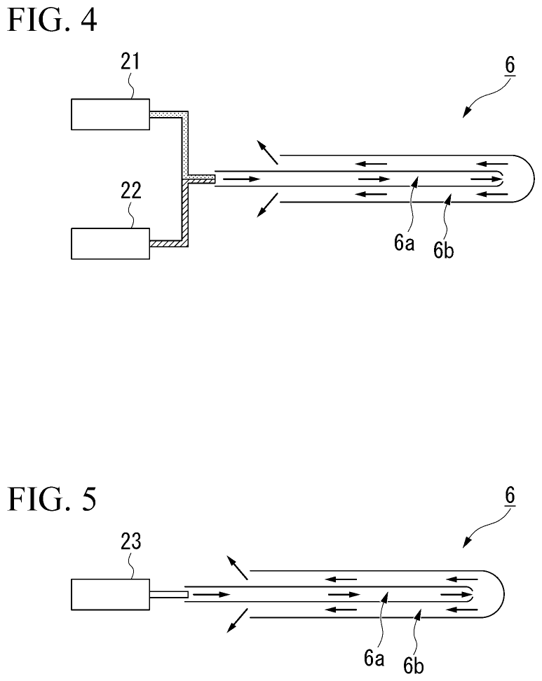

Next, an example of the temperature adjustment probe will be described with reference to FIGS. 4 and 5.

In order to achieve a sufficient cooling rate, examples of the preferable temperature control probes include one that uses the Joule-Thomson effect to adjust the temperature of the metal layers or the multilayer structure in the process of being manufactured, as shown in FIG. 4, and one that uses liquefied gas to cool the metal layers or the multilayer structure in the process of being manufactured.

By using these temperature adjustment probes, the time required to reach the target temperature by cooling is relatively shortened, it is possible to control for obtaining a metal structure that will not develop unless the target temperature is reached in a shorter time. In addition, by accelerating the cooling rate, it is also possible to control for obtaining a metal structure that only appears at a higher cooling rate.

The temperature adjustment probe 6 shown in FIG. 4 is connected to an argon supply source 21 and a helium supply source 22. A nozzle (not shown) is provided in the temperature adjustment probe 6, and uses the Joule-Thomson effect to control the temperature at the tip of the probe by heating or cooling.

For example, in order to perform a cooling process, argon gas is brought to a higher pressure than atmospheric pressure, the high-pressure argon gas is reduced to atmospheric pressure by a nozzle (not shown), and the argon gas can be instantaneously cooled by the Joule-Thomson effect. In addition, when performing heating treatment, the supply of argon gas is stopped, the helium gas is brought to a higher pressure than atmospheric pressure, and the high-pressure helium gas is reduced to atmospheric pressure using a nozzle (not shown). Helium gas can be heated instantly by the Thomson effect.

In this way, according to the temperature adjustment probe 6 shown in FIG. 4, rapid heating processing and rapid cooling processing are possible by utilizing the temperature change of the gas due to the Joule-Thomson effect. However, the configuration of the temperature adjustment probe is not particularly limited to the configuration shown in FIG. 4, as long as it can utilize the Joule-Thomson effect. Furthermore, the gas for obtaining the Joule-Thomson effect is not particularly limited.

The temperature adjustment probe 6 shown in FIG. 5 is connected to a liquefied gas supply source 23. According to the temperature adjustment probe 6 shown in FIG. 5, rapid cooling processing can be performed by cooling the probe itself using the low temperature characteristics of liquefied gas.

According to the temperature adjustment probe 6 shown in shown in FIGS. 4 and 5 as an example of the temperature adjustment probe using gas, it is possible to utilize the Joule-Thomson effect or the low-temperature characteristics of liquefied gas, and reduce power consumption compared to cooling mechanisms that use electricity.

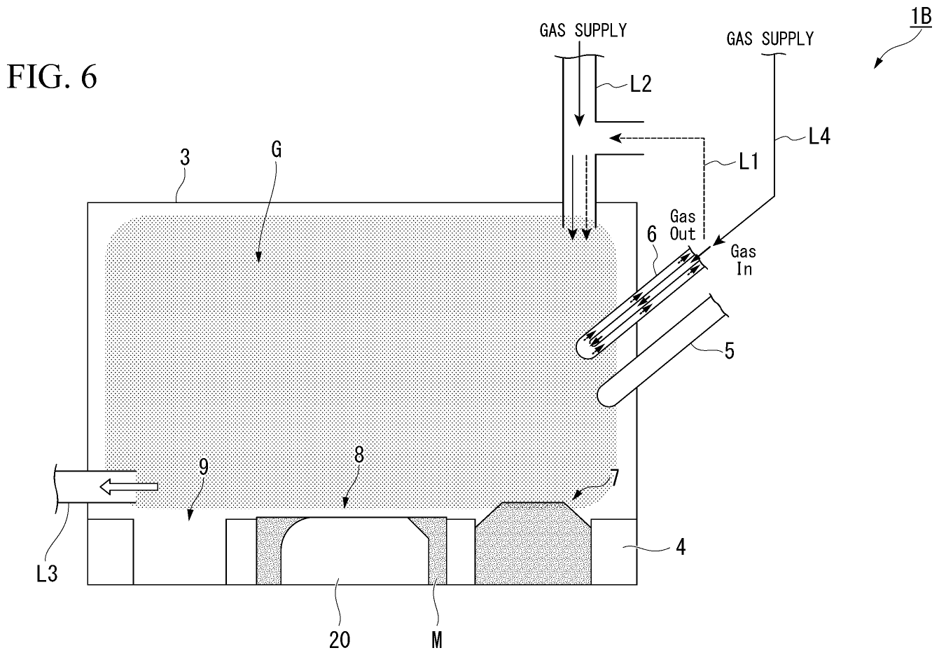

FIG. 6 is a schematic diagram showing another example of a multilayer structure manufacturing device. In FIG. 6, illustration of the irradiation unit 20 is omitted for the sake of simplifying the explanation.

The multilayer structure manufacturing device 1B shown in FIG. 6 is different from the multilayer structure manufacturing device 1A in that an exhaust line L1 through which the gas exhausted from the temperature adjustment probe 6 flows and a shield gas supply line L2 through which the shield gas supplied into the chamber 3 flows are connected.

According to the multilayer structure manufacturing device 1B shown in FIG. 6, in addition to being able to control the cooling rate of the multilayer structure, the atmospheric gas G in the chamber 3 can be heated or cooled by supplying gas to the temperature adjustment probe and adjusting the temperature of the gas introduced into the chamber 3. Therefore, the cooling rate of the multilayer structure can be controlled through the atmospheric gas G in the chamber 3. In this case, an exhaust line L3 for discharging the shield gas to the outside of the chamber 3 is connected to the chamber 3.

In addition, according to the multilayer structure manufacturing device 1B shown in FIG. 6, the gas supplied from a line L4 into the temperature adjustment probe 6 can be returned into the chamber 3 after passing through the temperature adjustment probe 6, so that the gas can be efficiently can be used.

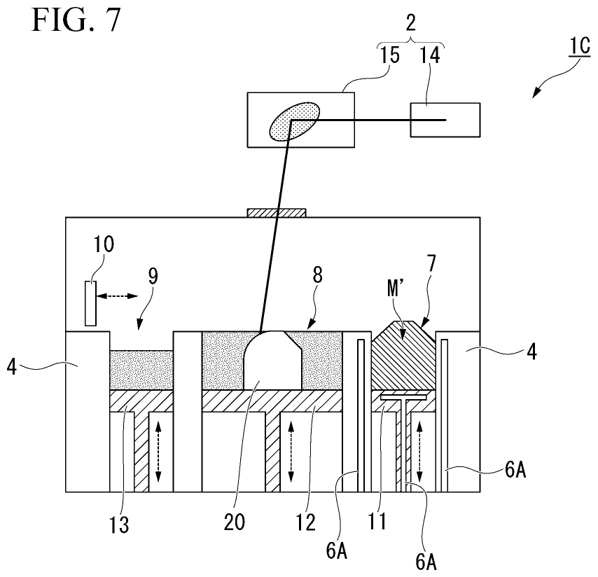

FIG. 7 is a schematic diagram showing another example of a multilayer structure manufacturing device.

The multilayer structure manufacturing device 1C shown in FIG. 7 differs from the multilayer structure manufacturing device 1A in that a plurality of the temperature measurement probes 5A and a plurality of the temperature adjustment probes 6A are embedded inside the storage section 7 of the build stage 4.

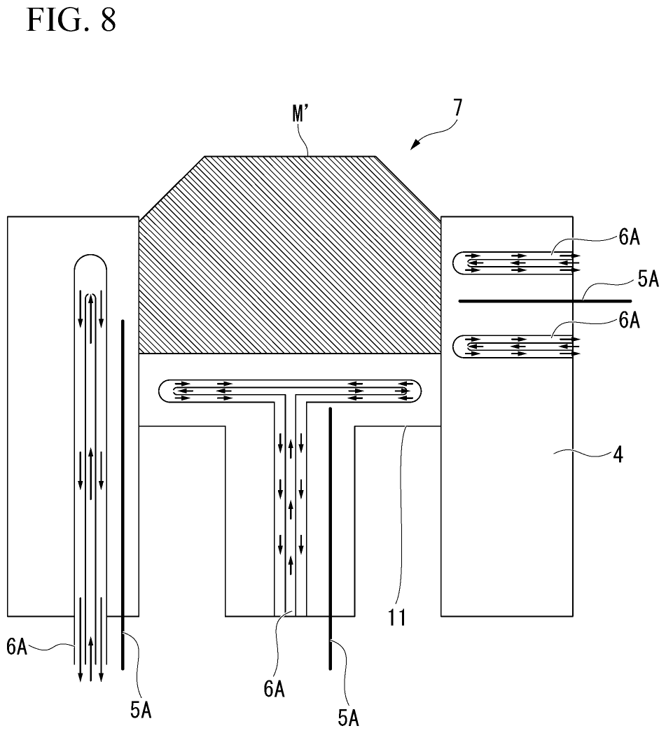

FIG. 8 is a schematic diagram showing the storage section 7 of the build stage 4 of the multilayer structure manufacturing device 1C in FIG. 7. As shown in FIG. 8, a plurality of the temperature measurement probes 5A and the temperature adjustment probes 6A are embedded inside the storage section 7 of the build stage 4. The shape of each temperature measurement probe 5A and each temperature adjustment probe 6A is not limited in any way, and can be changed according to the shape of the build stage 4, the members (for example, the first lifting table 11) constituting the storage section 7, and the wall surface.

According to the multilayer structure manufacturing device 1C, the temperature of the metal powder M′ before laser irradiation in the storage section 7 can be adjusted by heating or cooling. By supplying the metal powder M′ of which the temperature has been adjusted in this way to the powder bed 8 with the blade 10, the temperature of any metal layer can be adjusted, and the cooling rate can be controlled. In this case as well, when the cooling rate of the metal layer or the multilayer structure in the process of being manufactured is controlled by the temperature measurement probe 5A and the temperature adjustment probe 6A, the formation of the powder layer before laser irradiation, the formation of the metal layer, and the fabricating of the multilayer structure are not easily interfered.

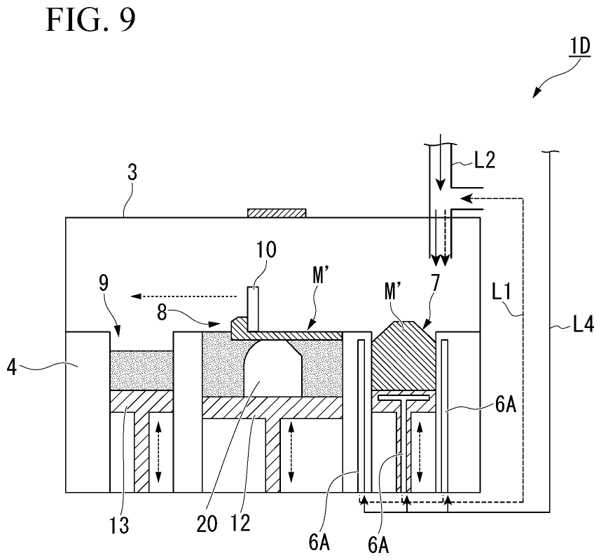

FIG. 9 is a schematic diagram showing another example of a multilayer structure manufacturing device. In FIG. 9, illustration of the irradiation unit 20 is omitted for the sake of simplification of explanation.

The multilayer structure manufacturing device 1D shown in FIG. 9 is different from the multilayer structure manufacturing device 1C in that an exhaust line L1 through which the gas exhausted from the temperature adjustment probe 6A embedded in the storage section 7 flows and a shield gas supply line L2 through which the shield gas supplied into the chamber 3 flows are connected.

According to the multilayer structure manufacturing device 1D, the temperature of the metal powder M′ before laser irradiation in the storage section 7 can be adjusted by heating or cooling. By supplying the metal powder M′ of which the temperature has been adjusted in this way to the powder bed 8 with the blade 10, the temperature of any metal layer can be adjusted, and the cooling rate can be controlled.

Further, the gas exhausted from the temperature adjustment probe 6A and the shielding gas supplied to the chamber 3 can be mixed. Therefore, the temperature of the gas introduced into the chamber 3 can be adjusted by supplying gas into the temperature adjustment probe 6A, and the atmospheric gas in the chamber 3 can be heated or cooled. Therefore, the cooling rate of the multilayer structure can be controlled through the atmospheric gas inside the chamber 3.

In the multilayer structure manufacturing device 1D as well, the gas supplied from the line L4 into the temperature adjustment probe 6A can be returned into the chamber 3 after passing through the probe, making it possible to efficiently utilize the gas.

The multilayer structure manufacturing device according to the present embodiments can employ any of the PBF method, DED method, and WAAM (Wire Arc Additive Manufacturing) method. No matter which of these methods is adopted, in the present embodiment, at least one of the plurality of temperature measurement probes and at least one of the plurality of temperature adjustment probes are embedded inside the powder bed of the build stage. Therefore, controlling the cooling rate hardly interferes with the formation of the powder layer, the formation of the metal layers, and the fabricating of the multilayer structure.

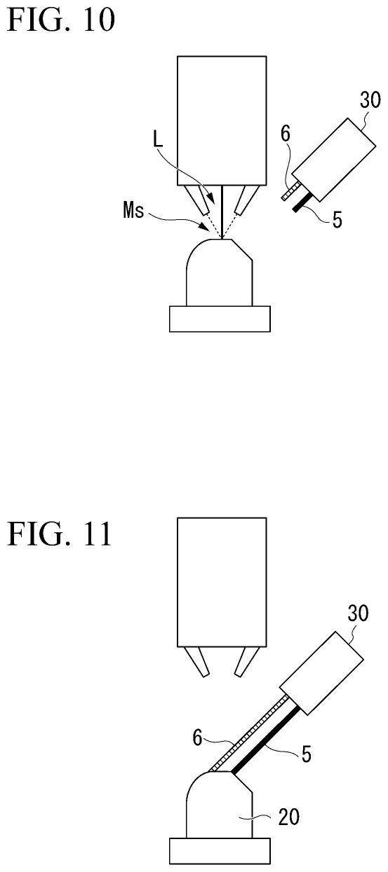

FIGS. 10 and 11 are schematic diagrams showing the operations of the temperature adjustment probe and the temperature measurement probe in a DED type multilayer structure manufacturing device.

In the DED method, metal powder Ms is injected at the portion irradiated with the laser L to form a metal layer. For example, after forming and layering a metal layer as shown in FIG. 10, the temperature measurement probe 5 and the temperature adjustment probe 6 are extended as shown in FIG. 11, and the cooling rate of any metal layer or any region of the multilayer structure 20 in the process of being manufactured may be controlled.

As in the example shown in FIGS. 10 and 11, the temperature measurement probe 5 and the temperature adjustment probe 6 may be integrally attached to one device 30.

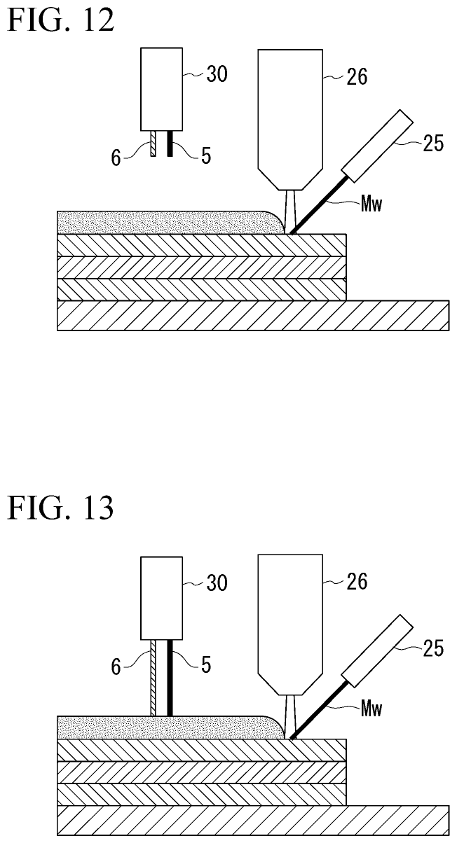

FIGS. 12 and 13 are schematic diagrams showing the operations of the temperature adjustment probe and the temperature measurement probe in a WAAM type multilayer structure manufacturing device.

In the WAAM method, arc welding is performed using a torch 26 while a metal wire Mw is supplied by a metal wire feeder 25. For example, as shown in FIG. 12, after forming and layering a metal layer, the temperature measurement probe 5 and the temperature adjustment probe 6 are extended as shown in FIG. 13, and the cooling rate of an arbitrary area may be controlled.

In the present embodiment, as a method for cooling the metal, it is also possible to cool the metal before melting by using the atmospheric gas in the chamber 3.

In the case of the DED method, the metal powder to be supplied can be heated or cooled by providing a temperature adjustment mechanism such as the temperature adjustment probe in a path in which the metal powder to be supplied flows or in the tank of the metal powder. For example, by spraying cooled metal powder at the molten part, it is possible to cool the outermost metal layer of the multilayer structure in the process of being manufactured.

In the case of the WAAM method, the metal wire to be supplied can be heated or cooled by providing a temperature adjustment mechanism such as the temperature adjustment probe in the path of the metal wire to be supplied. For example, by using a cooled metal wire, it is possible to cool the outermost metal layer of the multilayer structure in the process of being manufactured.

By adjusting the temperature of the outermost metal layer of the multilayer structure in the process of being manufactured in this way, the cooling rate of any metal layer or any region of the multilayer structure in the process of being manufactured can be controlled.

According to the multilayer structure manufacturing device according to the present embodiment, a rapid cooling rate that could not be achieved with the conventional technology can be achieved. Therefore, it is possible to perform control to obtain a metal structure that can only be developed with shorter cooling times (instantaneous) or higher cooling rates.

For example, when a titanium alloy is used, anisotropy in yield stress and hardness can be imparted by the refinement of the crystal structure due to the rapid cooling effect. In addition, when a stainless steel is used, the cooling rate can be increased to promote the formation of crystalline precipitates and provide excellent corrosion resistance. Moreover, oxidation reactions of metal materials can also be suppressed.

### EXPLANATION OF REFERENCE NUMERALS

1 multilayer structure manufacturing device
2 irradiation section
3 chamber
4 build stage
5 temperature measurement probe
6 temperature adjustment probe
7 storage section
8 powder bed
9 collection section
10 blade
11 first lifting table
12 second lifting table
13 third lifting table
14 laser oscillator
15 optical system
M metal powder

1-7. (canceled)

8. A multilayer structure manufacturing device that manufactures a multilayer structure by layering multiple metal layers,
wherein the multilayer structure manufacturing device comprises:
a heat source which forms the metal layer;
a mechanism which supplies metal material;
a chamber;
a build stage that is movable in the vertical direction in the chamber;
one or more temperature measurement probes that measure the temperature of the metal layer or the multilayer structure in the process of being manufactured; and
one or more temperature adjustment probes that adjust the temperature of the metal layer or the multilayer structure in the process of being manufactured; and
wherein at least one of the temperature measurement probes and at least one of the temperature adjustment probes are extendably installed such that the tip thereof is disposed in the chamber; and/or at least one of the temperature measurement probes and at least one of the temperature adjustment probes are installed such that the tip thereof is disposed in the chamber and an exhaust line through which gas exhausted from the temperature adjustment probe flows and a shield gas supply line through which a shield gas supplied into the chamber flows are connected, and/or the build stage comprises a powder bed of metal powder and at least one of the temperature measurement probes and at least one of the temperature adjustment probes are embedded in a part constituting the powder bed, and
wherein the temperature adjustment probe adjusts the temperature of the metal layer or the multilayer structure in the process of being manufactured using the Joule-Thomson effect, and/or liquefied gas.

9. The multilayer structure manufacturing device according to claim 8,
wherein the temperature adjustment probe which is extendably installed extends and contacts the metal layer or the multilayer structure in the process of being manufactured, and adjusts the temperature of the metal layer or the multilayer structure in the process of being manufactured.

10. The multilayer structure manufacturing device according to claim 8,
wherein gas exhausted from the temperature adjustment probe is introduced into the shield gas supply line through the exhaust line and supplied into the chamber.

11. The multilayer structure manufacturing device according to claim 9,
wherein gas exhausted from the temperature adjustment probe is introduced into the shield gas supply line through the exhaust line and supplied into the chamber.

12. The multilayer structure manufacturing device according to claim 8,
wherein the build stage further comprises a storage section that stores metal powder,
wherein at least one of the temperature adjustment probes is embedded in a part constituting the storage section of the build stage.

13. The multilayer structure manufacturing device according to claim 8,
wherein the multilayer structure manufacturing device is in a direct energy deposition manner which manufactures a multilayer structure by layering multiple metal layers formed by supplying metal wire or metal powder to a part at which a direct energy is generated,
wherein the multilayer structure manufacturing device comprises a supply device which supplies the metal wire or the metal powder, and
wherein at least one temperature adjustment probe is embedded at least one of inside of the supply device and inside of a supply line for the metal wire or the metal powder from the supply device.

14. The multilayer structure manufacturing device according to claim 9,
wherein the multilayer structure manufacturing device is in a direct energy deposition manner which manufactures a multilayer structure by layering multiple metal layers formed by supplying metal wire or metal powder to a part at which a direct energy is generated,
wherein the multilayer structure manufacturing device comprises a supply device which supplies the metal wire or the metal powder, and
wherein at least one temperature adjustment probe is embedded at least one of inside of the supply device and inside of a supply line for the metal wire or the metal powder from the supply device.

15. The multilayer structure manufacturing device according to claim 10,
wherein the multilayer structure manufacturing device is in a direct energy deposition manner which manufactures a multilayer structure by layering multiple metal layers formed by supplying metal wire or metal powder to a part at which a direct energy is generated,
wherein the multilayer structure manufacturing device comprises a supply device which supplies the metal wire or the metal powder, and
wherein at least one temperature adjustment probe is embedded at least one of inside of the supply device and inside of a supply line for the metal wire or the metal powder from the supply device.

16. A multilayer structure manufacturing method using the multilayer structure manufacturing device according to claim 8,
wherein the method comprises:
a step in which the cooling rate of the metal layer or the multilayer structure in the process of being manufactured is controlled by using the temperature measurement probe and the temperature adjustment probe.

17. A multilayer structure manufacturing method using the multilayer structure manufacturing device according to claim 9,
wherein the method comprises:
a step in which the cooling rate of the metal layer or the multilayer structure in the process of being manufactured is controlled by using the temperature measurement probe and the temperature adjustment probe.

18. A multilayer structure manufacturing method using the multilayer structure manufacturing device according to claim 10,
wherein the method comprises:
a step in which the cooling rate of the metal layer or the multilayer structure in the process of being manufactured is controlled by using the temperature measurement probe and the temperature adjustment probe.

19. A multilayer structure manufacturing method using the multilayer structure manufacturing device according to claim 11,
wherein the method comprises:
a step in which the cooling rate of the metal layer or the multilayer structure in the process of being manufactured is controlled by using the temperature measurement probe and the temperature adjustment probe.

20. A multilayer structure manufacturing method using the multilayer structure manufacturing device according to claim 12,
wherein the method comprises:
a step in which the cooling rate of the metal layer or the multilayer structure in the process of being manufactured is controlled by using the temperature measurement probe and the temperature adjustment probe.

21. A multilayer structure manufacturing method using the multilayer structure manufacturing device according to claim 13,
wherein the method comprises:
a step in which the cooling rate of the metal layer or the multilayer structure in the process of being manufactured is controlled by using the temperature measurement probe and the temperature adjustment probe.

22. A multilayer structure manufacturing method using the multilayer structure manufacturing device according to claim 14,
wherein the method comprises:
a step in which the cooling rate of the metal layer or the multilayer structure in the process of being manufactured is controlled by using the temperature measurement probe and the temperature adjustment probe.

23. A multilayer structure manufacturing method using the multilayer structure manufacturing device according to claim 15,
wherein the method comprises:
a step in which the cooling rate of the metal layer or the multilayer structure in the process of being manufactured is controlled by using the temperature measurement probe and the temperature adjustment probe.
